(19) United States
(12) Patent Application Publication
(10) Pub. No.: US 2020/0070456 A1
(43) Pub. Date: Mar. 5, 2020

(54) FOAM MOLDED BODY, SHOE COMPONENT AND MANUFACTURING METHOD THEREOF

(71) Applicant: Sheng Long Material Tech. Ltd. (WS), Apia (WS)

(72) Inventor: CHIN-HSUN HSIAO, Taipei (TW)

(21) Appl. No.: 16/553,722

(22) Filed: Aug. 28, 2019

(30) Foreign Application Priority Data
Aug. 31, 2018 (TW) 107130724

(51) Int. Cl. B29D 35/14; A43B 7/12; B29D 35/00

(52) U.S. Cl. CPC B29D 35/142; B29K 2075/00; B29D 35/0018; A43B 7/125

(57) ABSTRACT

The present invention provides a method for manufacturing a foam molded body, including: a setting step of inputting a foam matrix material into a mold that is not affected by microwaves, wherein the foam matrix material includes a plurality of half-foamed granules of thermoplastic polyurethanes (TPU) and at least an embedded component, and the embedded component is of a material or its product that is not affected by microwaves; and a foaming step of heating the mold by microwaves, wherein the half-foamed granules in the mold are affected by microwaves such that the temperature thereof are raised to effect foaming and the granules are squeezed with each other, and the embedded component is therefore squeezed and fixed, so as to form a foam molded body embedded with an embedded component after cooling and demolding.

### BACKGROUND

### Technical Field

The present invention relates to a foam molded body, a shoe component and the manufacturing method thereof. In particular, the present invention relates to a foam molded body, a shoe component, and the manufacturing method thereof which are having embedded component.

### Related Art

Plastic/rubber molded bodies have been widely used in various fields in the world to manufacture various utensils or products such as toys, shoes, auto parts, electronic parts, etc. According to the above, it is common to use injection molding to heat and melt plastic at a high temperature and inject it into a mold to form various plastic/rubber molded bodies. However, in such a process, it is necessary to use an injection molding machine and a relatively high-temperature resistant mold, hence the configurations required and costs of the overall procedure are relatively high. In addition, the high temperature of injection molding is also disadvantageous for adding any object to be embedded in the plastic/rubber molded body in the preparation. Therefore, it is necessary to develop plastic/rubber molded bodies of various structures and the methods for preparing such plastic/rubber molded bodies, and the corresponding detailed processes for various designs or products.

As described above, in order to provide plastic/rubber molded bodies of other structures, Taiwan Patent Publication No. TW 201736423 A proposes a foamable composition which can be used for foaming, a foamed thermoplastic polyurethane (TPU) granule which is formed by foaming and granulation, and the microwave molded bodies produced by the same and corresponding manufacturing methods thereof; Taiwan Patent Publication No. TW 201736450 A proposes a method of forming a microwave molded body on the surface portion of an object and a microwave molded body thereof; and Taiwan Patent Publication No. TW 201736093 A proposes a method corresponding to formation of a microwave molded shoe and a microwave molded shoe produced therefrom. The above-mentioned Taiwan Patent Publications disclose several foamed granular materials especially designed to adjust the granule color or the granule hardness during granulation, and discloses fittings or objects that can be bonded with the foamed granular material by an adhesive layer or fused with the foamed granular material by microwave heating. However, the present invention further proposes materials that can be applied depending on the nature of microwave heating and various configurations of foaming, in order to further provide a method and a finished product thereof for preparing various detailed structures and configurations of microwave molded bodies.

### SUMMARY

Technical Means for Problem Solving.

In order to solve the above problems, an embodiment of the present invention provides a method of producing a foam molded body. The method includes a setting step of inputting a foam matrix material into a mold that is not affected by microwaves, wherein the foam matrix material includes a plurality of half-foamed granules of thermoplastic polyurethanes (TPU) and at least an embedded component, and the embedded component is of a material or its product that is not affected by microwaves; and a foaming step of heating the mold by microwaves, wherein the half-foamed granules in the mold are affected by microwaves such that the temperature of the granules are raised to effect foaming and the granules squeeze each other, and the embedded component is therefore squeezed and fixed, so as to form the foam molded body embedded with the embedded component after cooling and demolding.

According to another embodiment of the present invention, there is provided a foam molded body produced by the above method, and wherein the embedded component is squeezed and firmly embedded in a foamed structure in which the surfaces of the half-foamed granules are squeezed and welded to each other by foaming.

According to another embodiment of the present invention, a shoe component made by the above method is provided. The shoe component is a foam molded body having a shape of a shoe component, and the embedded component is squeezed and firmly embedded in a foamed structure in which the surfaces of the half-foamed granules are squeezed and welded to each other by foaming.

According to another embodiment of the present invention, there is provided a foam molded body comprising a foamed structure formed by foaming a plurality of half-foamed granules of thermoplastic polyurethane (TPU) and at least an embedded component, and the embedded component is of a material or its product that is not affected by microwaves. Wherein, the embedded component is squeezed and firmly embedded in a foamed structure in which the surfaces of the half-foamed granules are squeezed and welded to each other by foaming.

Contrast the Efficacy of Prior Art.

According to the embodiment of the present invention, the method for producing a foam molded body, the foam molded body, and the shoe component are different from common high-temperature injection molding, and can simultaneously embed an embedded component which has different properties from the main body of the foam molded body and not affected by microwaves at the time of microwave foaming. Thus a foam molded body with embedded component which is integrally-formed with the whole structure can be obtained. Thereby, the simplified process can set more kinds of embedded components, and the finished product can have a more complete integrated appearance, thus improving the fineness and applicability of the foam molded body.

### BRIEF DESCRIPTION OF THE DRAWINGS

FIG. 1 shows a flow chart of a method of producing a foam molded body according to an embodiment of the present invention.

FIG. 2A to FIG. 2C are schematic diagrams of the foaming matrix material with embedded components according to an embodiment of the present invention.

FIG. 2D is a schematic diagram of foaming in the manner of microwave heating according to an embodiment of the present invention.

FIG. 2E is a schematic diagram of producing a foam molded body by the method shown in FIG. 2A to FIG.2D.

FIG. 2F is a schematic diagram of producing a foam molded body with a mold having the shape of a shoe component according to an embodiment of the present invention.

FIG. 3A is a schematic diagram of setting the foaming matrix material with embedded component according to another embodiment of the present invention.

FIG. 3B is a schematic diagram of foaming by microwave heating according to another embodiment of the present invention.

FIG. 4A is a schematic diagram of setting the foaming matrix material with embedded components according to another embodiment of the present invention.

FIG. 4B is a schematic diagram of foaming by microwave heating according to another embodiment of the present invention.

FIG. 5A to FIG. 5D are schematic diagrams of setting the foaming matrix material with embedded components and different granule size range of half-foamed granules according to another embodiment of the present invention.

FIG. 5E is a schematic diagram of foaming by microwave heating according to another embodiment of the present invention.

FIG. 6 is a schematic diagram of producing a foam molded body by the method shown in FIG. 5A to FIG.5E.

FIG. 7A and FIG. 7B are schematic diagrams of setting the foaming matrix material with embedded components and different granule size range of half-foamed granules, and foaming by microwave heating according to another embodiment of the present invention.

FIG. 8 is a schematic diagram of setting the foaming matrix material and film-like component according to one embodiment of the present invention.

FIG. 9 is a schematic diagram of the foam molded body produced by foaming by microwave heating in the configuration of FIG. 8.

FIG. 10A to FIG. 10D are the schematic diagrams of setting foaming matrix material and film-like component according to another embodiment of the present invention.

FIG. 10E is a schematic diagram of foaming by microwave heating according to another embodiment of the present invention.

FIG. 11 is a schematic diagram of producing a foam molded body by the method shown in FIG. 10A to FIG.10E.

FIG. 12A and FIG. 12B are the schematic diagrams of setting the foaming matrix material, shoe last and upper according to another embodiment of the present invention.

FIG. 13 is a schematic diagram of the shoe component produced by foaming via microwave heating and the shoe component bonded to the upper in the configuration of the FIG. 12A and FIG. 12B.

FIG. 14 is a schematic diagram of setting a foaming matrix material, a shoe last and an upper according to a first variant embodiment of the present invention.

FIG. 15 is a schematic diagram of a shoe component and an insole produced by microwave heating and the shoe component bonded to the upper in the configuration of FIG. 14.

FIG. 16 is a schematic diagram of setting a foaming matrix material, a shoe last and an upper according to a second variant embodiment of the present invention.

FIG. 17 is a schematic diagram of a shoe component and an insole produced by microwave heating and the shoe component bonded to the upper in the configuration of FIG. 16.

### DETAILED DESCRIPTION

Various embodiments will be described hereinafter, and for one skilled in the art having ordinary knowledge in the description with reference to the drawings, the spirit and principle of the present invention should be readily understood. However, although some specific embodiments will be specified in this article, these embodiments are to be considered as illustrative and not restrictive or limiting. Therefore, for those who have general knowledge in the technical field of their own, without departing from the spirit and principles of the present invention, the various changes and modifications to the present invention should be obvious and easily achievable.

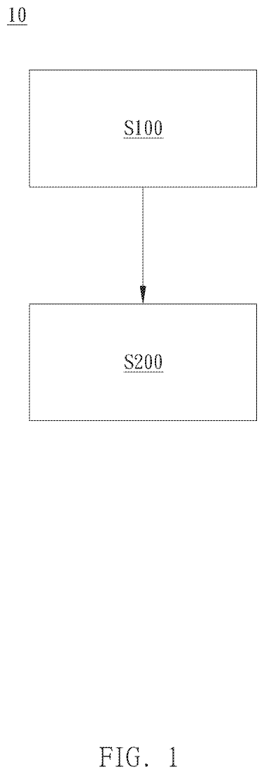

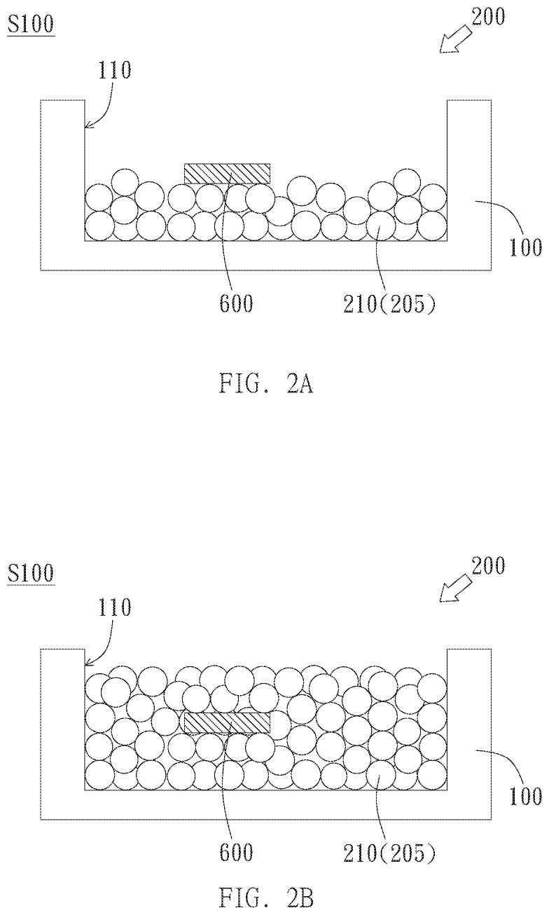

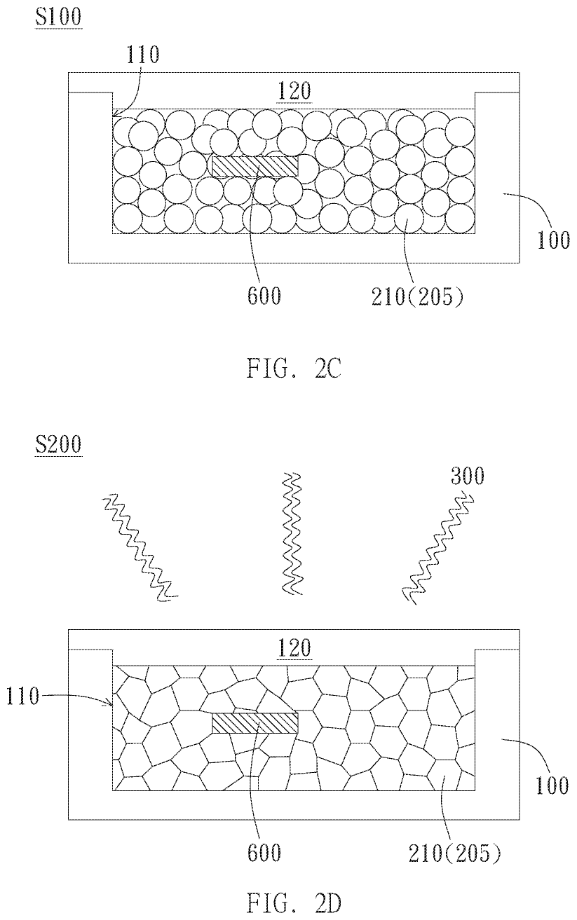

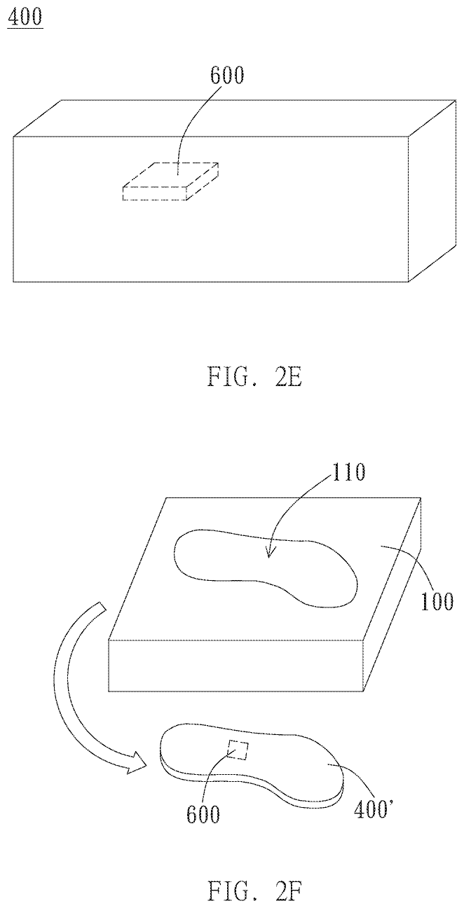

As shown in FIG. 1, according to an embodiment of the present invention, a method of fabricating a foam molded body 10 includes a setting step S100 for setting a foam matrix material, and a foaming step S200 for foaming the foam matrix material. For example, with reference to FIG. 1 and FIG. 2A to FIG. 2C, according to the method 10 of the present embodiment, the setting step S100 involves placing the foam matrix material 200 in the mold 100 which is not affected by microwaves (i.e., in the cavity 110 of the mold 100). In particular, “not affected by microwaves” means, for example, it cannot be heated by microwaves and can withstand the temperature rise caused by microwave heating. Specifically, an ultra-transparent, low-loss material allows microwaves to easily pass through and not be absorbed; or, a completely opaque material such as a metal conductor reflects all incoming microwaves and does not allow microwaves to penetrate. Such materials, which cannot be heated by microwaves, are not affected by microwaves unless they are denatured or changed by the temperature rise of other materials around them (e.g. foaming). On the other hand, a high-loss material sensitive to microwaves can absorb the microwaves after the microwaves come in for a certain distance, hence it can be heated by absorbing microwaves and is a material that can be affected by microwaves. In addition, even if a material is not capable of directly absorbing microwaves and becoming heated, however, if the material can be denatured or changed (such as foaming) by a rise in ambient temperature when other materials in the periphery absorb microwaves, it is a material that can be affected by microwaves.

As described above, according to an embodiment of the present invention, the foam matrix material 200 comprises a plurality of half-foamed granules 205 that can be foamed directly by microwave heating or by temperature rise caused by heating other adjacent materials and at least one embedded component 600 that is not affected by microwave. For example, the half-foamed granules 205 of the foam matrix material 200 may be high loss materials that can be heated by microwave heating. Alternatively, in the case where the half-foamed granules 205 are difficult to be heated by microwaves, an additive which easily absorbs microwaves (for example, Al 2 O 3 —SiC, etc.) may be further added to the foam matrix material 200, so that the half-foamed granules 205 can be foamed by the temperature increase caused by the absorption of microwaves by the surrounding additives.

Here, the mold 100 that is not affected by microwaves, for example, may be a mold 100 made of a material that does not rise in temperature from being affected by microwaves, and/or a material that can withstand high temperature without deformation. Further, the mold 100 (the cavity 110 of the mold 100) may have various desired shapes to thereby produce a foam molded body with a desired shape, and may be integrally formed or assembled from a plurality of components.

According to some embodiments of the present invention, the half-foamed granules 205 may be made of polyurethane (PU), thermoplastic polyurethane (TPU) or thermoplastic elastomer (TPE), and can be a certain size of granules with foaming ability after a certain degree of foaming. Specifically, the material of polyurethane (PU), thermoplastic polyurethane (TPU) or thermoplastic elastomeric (TPE) can be mixed with foaming agent after plastic molding through incomplete foaming to form the half-foamed granules 205 which still retain foaming ability. For example, the half-foamed granules 205 may be formed by foaming thermoplastic polyurethane (TPU) through half-foaming. However, the present invention is not limited thereto, and the half-foamed granules 205 can be prepared by any means with a certain extent of foaming to form a granule form, and still retain the foaming ability.

In detail, according to the present embodiment, the half-foamed granules 205 disposed in the mold 100 may include a plurality of first granules 210 sized within a first granule size range. Since the shape of the granules used with various embodiments of the present invention may not be a true sphere but is close to a sphere, the granule size is defined as the length of the largest axis of the granules. As mentioned above, in the preferred embodiment, the median of the first granule size range is substantially equal to the average granule size of the first granule 210. However, due to factors such as process tolerances, a plurality of first granules 210 may be different in granule size, and the average granule size thereof is not necessarily equal to the median granule size. In addition, the first particle 210 with substantially equal particle size mentioned above is only an example. That is, in other embodiments of the present invention, the half-foamed granules 205 may be configured according to requirements and designs to contain various granules sized within different granule sizes ranges, which will be further described below.

As mentioned above, the embedded component 600 can be arranged in the mold 100 together with the half-foamed granules 205. For example, according to the present embodiment, in the setting step S100, as shown in sequence in FIG. 2A and FIG. 2B, the half-foamed granules 205 may be placed to a certain extent before at least one embedded component 600 is placed at a desired position, then the filling of the half-foamed granules 205 can resume so that the embedded component 600 is surrounded by the half-foamed granules 205. Wherein, the embedded component 600 can be made of a material that is not affected by microwaves. For example, the embedded component 600 can be made of a material that cannot be heated by microwaves, and thus the embedded component 600 can retain its original properties and forms after being microwaved.

According to a preferred embodiment, referring to FIG. 2C, the mold 100 may further include a top cover 120. After the foam matrix material 200 is placed in the locations as shown in FIG. 2A and FIG. 2B, the foaming space of foam matrix material 200 can be delimited by placing the top cover 120 on the mold 100.

Next, referring to FIG. 2D together with FIG. 1 and FIG. 2A to FIG. 2C, according to the method 10 of the embodiment, the foaming step S200 includes heating the mold 100 by microwave so that the half-foamed granules 205 in the mold 100 have an increase in temperature from the microwaves and start foaming and squeezing each other. That is, the mold 100 and the foam matrix material 200, which includes the above-described half-foamed granules 205 (i.e., the first granules 210) and the embedded component 600, may be heated together by the microwaves 300. Thereby, the half-foamed granules 205 can effect foaming (for example, the foaming due to the temperature rise of itself caused by microwaves or the temperature rise caused by surrounding materials such as additives.), and the embedded component 600 is not affected by microwaves (for example, it does not foam via microwave heating). As a result, referring to FIG. 2E, after foaming, the surfaces of the half-foamed granules 205 are squeezed and welded to each other, making the embedded component 600 therein also pressed and fixed. Thus, a foam molded body 400 which is embedded with the embedded component 600 is integrally formed after cooling and demolding. Wherein, the foam molded body 400 is not scattered and fragmented, and is viewed as an integrated object. At the same time, the embedded component 600 can be embedded in the integrally-formed foam molded body 400 as a dissimilar material while retaining the original shape and functional properties. That is, the embedded component 600 may be squeezed and firmly embedded in the foamed structure in which the surfaces of the half-foamed granules 205 are squeezed and welded to each other by foaming.

According to some embodiments of the present invention, for example, the above-mentioned embedded component 600 may include a wafer, a metal sheet, or any objects that are made of non-polar materials and cannot be heated by microwaves or that are made of other materials that are not affected by microwaves and can used as a decoration or functional component in the finished product of the foam molded body 400. For example, in some embodiments of the invention, the embedded component 600 can be a GPS tracking wafer, so that the real-time location of the product that are made of the foam molded body 400 can be tracked.

As mentioned above, the foam molded body 400 mentioned above can have various shapes depending on the shape of the mold 100 used in the setting step S100, and can be made into various products. For example, a foam molded body can be used as a shoe component. For example, referring to FIG. 2F, in a method of manufacturing a foam molded body according to other embodiments of the present invention, the cavity 110 of the mold 100 is in the shape of a shoe component. Therefore, after the setting step S100 and the foaming step S200 are performed similarly to the above, the foam molded body 400′ may have a shoe component shape (for example, a midsole, an outsole or an insole) and be a shoe component containing the embedded component 600. That is, the shoe component is a foam molded body 400′ in the shape of the shoe component, and the embedded component 600 is squeezed and firmly embedded in the foamed structure in which the surfaces of the half-foamed granules 205 are squeezed and welded to each other by foaming.

As noted above, according to an embodiment, the embedded component 600 can be a GPS tracking wafer. Therefore, in this case, it is possible to track the real-time location of a sports event participant or a person with self-care disability who is wearing shoes with the shoe component made of the foam molded body 400′.

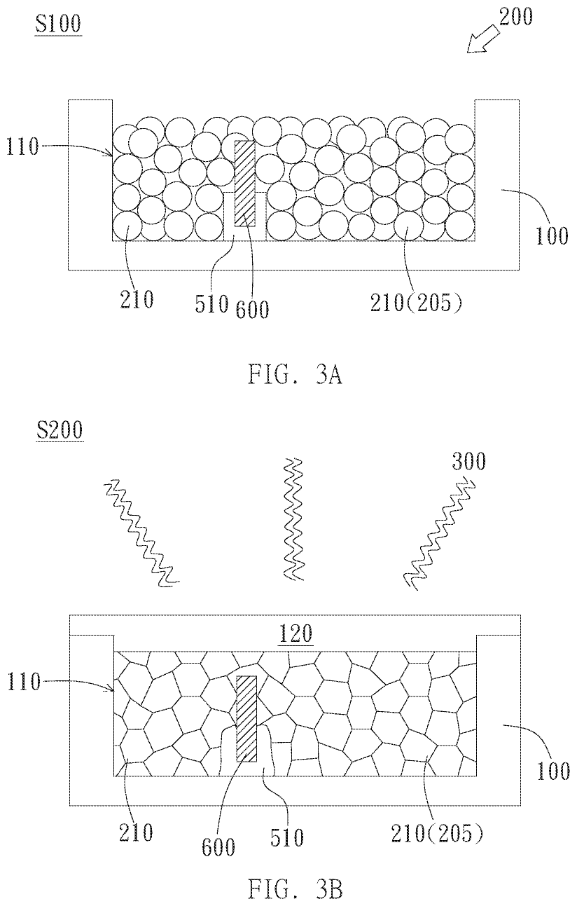

Next, with reference to FIG. 3A and FIG. 3B, we will describe the foam matrix material 200 and how foaming is done via microwaves according to another embodiment of the present invention.

Specifically, referring to FIG. 3A, in order to make the embedded component 600 set exactly in a desired position, in the setting step 100, one can use one or more positioning elements, such as base 510, to place the embedded component 600. One would then place the base 510, which holds the embedded component 600, in the mold 100 together with the half-foamed granules 205. Thereby, embedded component 600 can be positioned by the positioning element. Here, the positioning element, such as the base 510, can be made of a half-foamed material similar to the half-foamed granules 205. Therefore, the positioning element is not required to be taken out before the foaming step S200, and may be foamed by microwave heating together with the half-foamed granules 205 in the foaming step S200 as shown in FIG. 3B.

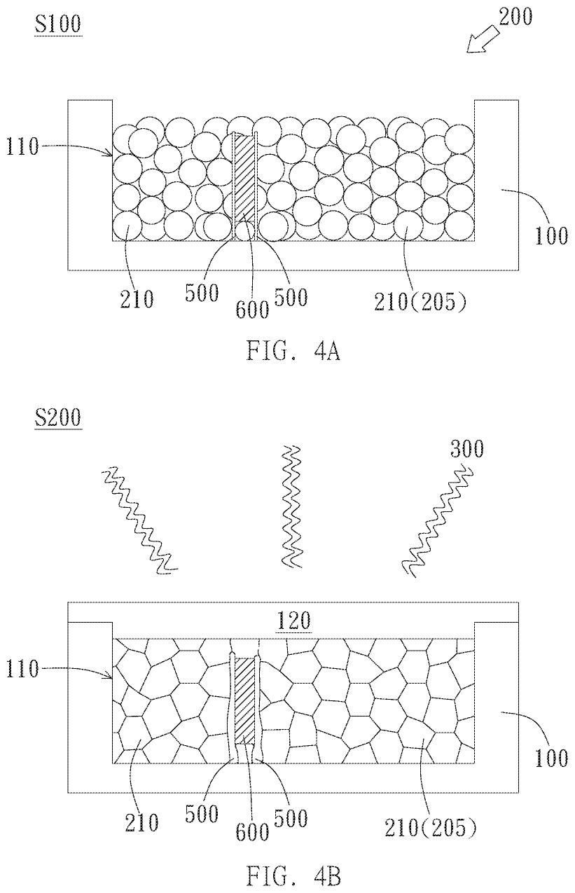

According to the above, the embedded component 600 can be set through various ways in the setting step 100. For example, the base 510 can be used as a positioning element. In addition, referring to FIG. 4A and FIG. 4B, in other embodiments of the present invention, one or more partitions 500 can be used as positioning elements to position the embedded component 600 in the setting step S100, and the partition 500 can also be made of a half-foamed material similar to the half-foamed granules 205. Therefore, the partition 500 are not required to be taken out before the foaming step S200, and may be foamed by microwave heating together with the half-foamed granules 205 in the foaming step S200 (for example, foaming due to temperature rise of itself caused by microwaves or temperature rise caused by surrounding materials such as additives). Thereby, the partition 500 and the surfaces of the half-foamed granules 205 will be welded to each other to form an integrally-formed foam molded body embedded with the embedded component 600.

As described above, in the setting step S100, the embedded component 600 can be disposed without the positioning element or with various positioning elements. That is to say, the method of directly embedding the embedded component 600 or using the base 510 or the partition 500 to embed the embedded component 600 as mentioned above are only examples. According to different embodiments, the embedded component 600 can be embedded in a manner other than the above.

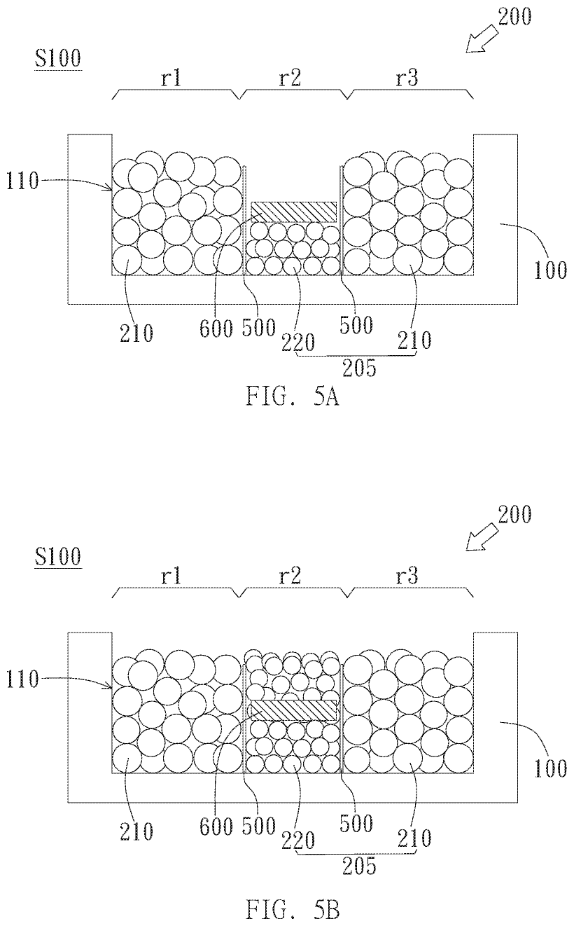

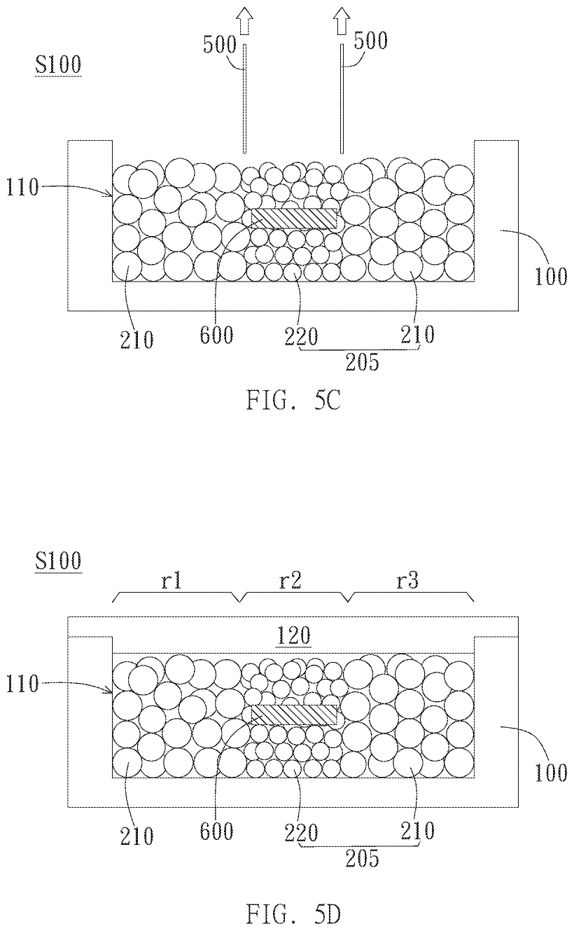

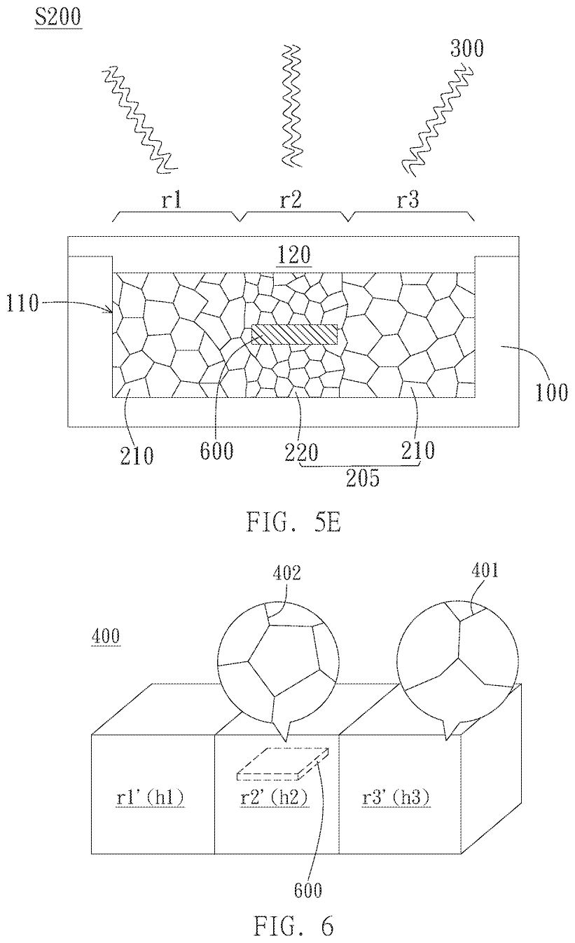

Further, the mold 100 can be additionally divided into different regions by a partition 500 similar to that described above with reference to FIG. 4A and FIG. 4B. For example, as an embodiment in FIG. 5A to FIG. 5E shows, the cavity 110 of the mold 100 can be divided into different regions r1, r2, and r3 using the partition 500. Then, a plurality of first granules 210 sized within a first granule size range and a plurality of second granules 220 sized within a second particle size range are respectively placed in different regions r1, r2 and r3 of the mold 100 separated by the partitions 500.That is, the half-foamed granules 205 may include: a plurality of first granules 210 sized within a first granule size range, and a plurality of second granules 220 sized within a second granule size range, and the first granules 210 and the second granules 220 can be set separately in different regions.

According to the present embodiment, the median of the first granule size range is substantially greater than the median of the second granule size range. That is, the first granules 210 are substantially larger than the second granules 220. In the preferred embodiment, the median of the first granule size range is substantially equal to the average granule size of the first granules 210 and the median of the second granule size range is substantially equal to the average granule size of the granules 220. However, due to factors such as process tolerance, there may be differences in granule size among the plurality of first granules 210 or among the plurality of second granules 220, and the average granule size thereof is not necessarily equal to the median.

As described above, the first granules 210 and the second granules 220 of different sizes may be disposed in different regions of the mold 100, respectively. For example, the first granules 210 may be disposed in the region r1 and the region r3, and the second granules 220 may be disposed in the region r2. However, the above are merely examples, and the mold 100 may be divided into several different regions in other forms, and the first granules 210 and the second granules 220 can be respectively disposed in different regions. In addition, according to other embodiments of the present invention, it is also possible to further include other granules sized within different granule size ranges according to the above principles, and these granules are different from the first granules 210 and the second granules 220, and are additionally disposed in different regions, respectively. The present invention is not limited thereto.

After the foam matrix material 200 is disposed as shown in FIG. 5A to FIG. 5B sequentially as described above, the foaming step S200 may be performed. Wherein, as shown in FIG. 5C, the partition 500 can be removed and, as shown in FIG. 5D and FIG. 5E, the content can be covered with the top cover 120 before the foaming step S200 is performed by using microwaves to heat the content to effect foaming (for example, foaming due to temperature rise of itself caused by microwaves or temperature rise caused by surrounding materials such as additives). Whereby, the surfaces of the half-foamed granules 205 are welded to each other to form an integrally-formed foam molded body embedded with the embedded component 600, as shown in FIG.6. However, here, if the partitions 500 are made of a half-foamed material that is similar to the half-foamed granules 205, there is no need to take them out before the foaming step S200 and, the partitions 500 can be heated with the half-foamed granules 205 using microwaves to effect foaming in the foaming step S200 (for example, foaming due to temperature rise of itself caused by microwaves or temperature rise caused by surrounding materials such as additives). Thereby, the partition 500 is welded to the surfaces of the half-foamed granules 205 to form an integrally-formed foam molded body embedded with the embedded component 600, as shown in FIG.6.

Referring to FIG. 6, the half-foamed granules 205 corresponding to the region r1 where the first granules 210 are originally disposed are formed as the first part r1′ of the foam molded body 400, the half-foamed granules 205 corresponding to the region r2 where the second granules 220 are originally disposed are formed as the second part r2′ of the foam molded body 400, and the half-foamed granules 205 corresponding to the region r3 where the first granules 210 are originally disposed are formed as the third part r3′ of the foam molded body 400. As mentioned above, the second part r2′ formed by the smaller second granules 220 has a higher density relative to the first part r1′ and the third part r3′ formed by the larger first granules 210. Therefore, the second part r2′ may have a higher hardness with respect to the first part r1′ and the third part r3′. That is, the hardness h2 of the second part r2′ may be higher than the hardness h1 of the first part r1′ and the hardness h3 of the third part r3′. In other words, the hardness of the part formed by the first granules 210 is less than the hardness of the part formed by the second granules 220. In addition, although only the first granules 210 and the second granules 220 are used in the present embodiment to form the foam molded body 400 with the two different hardness or softness embedded with the embedded component 600, according to other embodiments of the present invention, when it is expected that each part of the foam molded body 400 should have more than three kinds of harness or softness, other granules having other granules size ranges may be added corresponding to the above principle, and the present invention is not limited thereto.

Further, according to some embodiments of the present invention, referring to FIG. 6, in a completed foam molded body 400, the borders of the granules formed by mutual fusion of the surfaces of the half-foamed granules 205 can be seen. For example, the granule borders 401 in the first part r1′ and the third part r3′ formed by the foaming of the first granules 210 can be observed, and the granule borders 402 in the second part r2′ formed by the foaming of the second granules 220 can also be observed. The density of the granule borders 401 formed by the foaming of the first granules 210 may be lower than the density of the granule borders 402 of the part formed by the second granules 220. Further, according to some embodiments of the present invention, the granule borders of the foam molded body 400 may be difficult to see by the naked eye, or the granule borders may even be eliminated due to high degree of fusion between the surfaces after foaming. As such, the above description is merely exemplary of the granule borders, and the present invention is not limited thereto.

As described above, the hardness or softness of each part of the foam molded body 400 embedded with the embedded component 600 can be configured and prepared on the basis of requirements and designs. For example, when the foam molded body 400′ of the shoe component as shown in FIG. 2F is formed according to the above manner, the hardness or softness can be controlled based on factors such as the comfort expected for the wearer's foot. For example, the softer part of the produced shoe component (e.g., midsole, sole or insole) may correspond to the part of the shoe component that is expected to be in contact with the wearer's foot to increase wearing comfort, and the harder part corresponds to the part of the shoe component that is not expected to be in contact with the wearer's foot to increase support. However, the above descriptions are merely examples, and the present invention is not limited thereto.

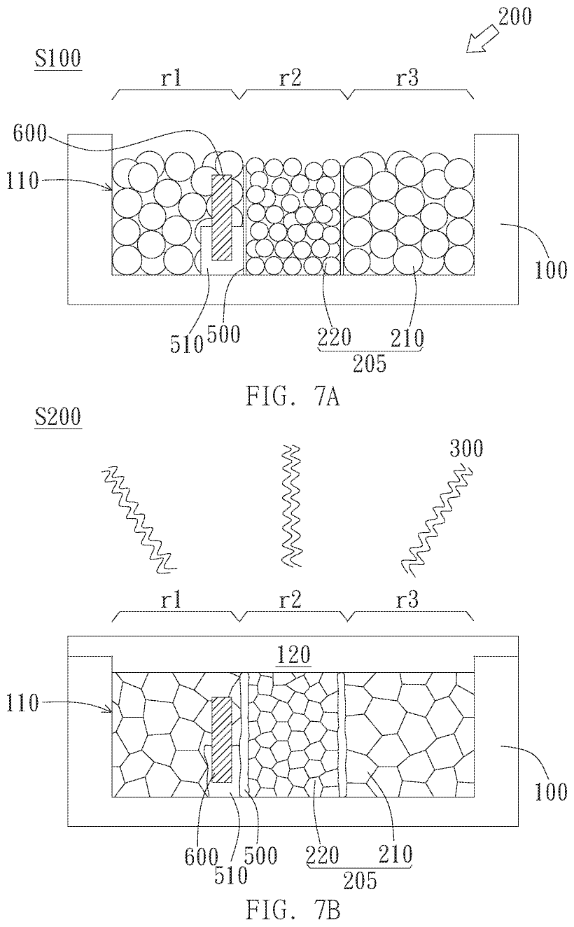

Further, the ways the foam matrix material 200 is configured in each of the above embodiments can be variously combined or changed provided that they do not conflict with each other. For example, with reference to FIG. 7A and FIG. 7B, one can use the base 510 to set the embedded component 600 in a manner similar to what is described in FIG. 3A and FIG. 3B, and use a partition 500 (and optionally not removing the partition 500) and granules with different granule size range to foam an integrally-formed foam molded body 400 that is embedded with the embedded component 600 in a manner similar to what is described in FIG. 5A to FIG.5E. However, this is merely an example, and other combinations and variations are possible in accordance with different embodiments of the invention.

Further, according to other embodiments of the present invention, one or more film-like components 700 may be partially disposed in the mold 100 in the setting step S100 to be in contact with the half-foamed granules 205 (for example, the first granules 210 and /or the second granules 220). Wherein, the film-like components 700 may include, for example, a material that can be heated by microwaves. For example, the film-like components 700 may include a material similar to the half-foamed granules 205, or the material that may be bonded to the half-foamed granules 205 after microwaving. For example, the film-like components 700 may include a material such as PU, TPU or TPE. Therefore, after microwaving, the film-like components 700 can be bonded to the foaming half-foamed granules 205.

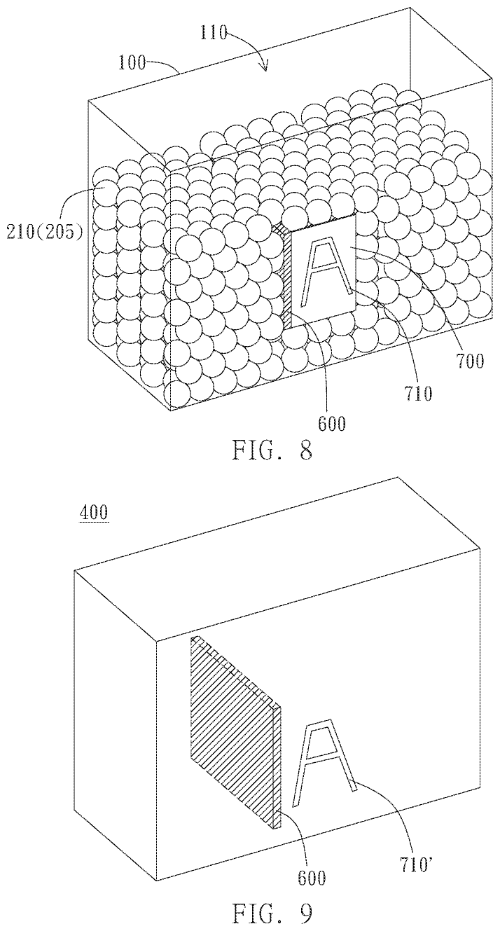

As mentioned above, for example, referring to FIG. 8, in addition to the half-foamed granules 205 and the embedded component 600 described above, a film-like component 700 with a pattern 710 can be further disposed in the mold 100 in the setting step 5100. Here, for the convenience of display, the mold 100 in the FIG. 8 is perspective, and the wall of the mold 100 that is used to define the cavity 110 is thin enough to be neglected.

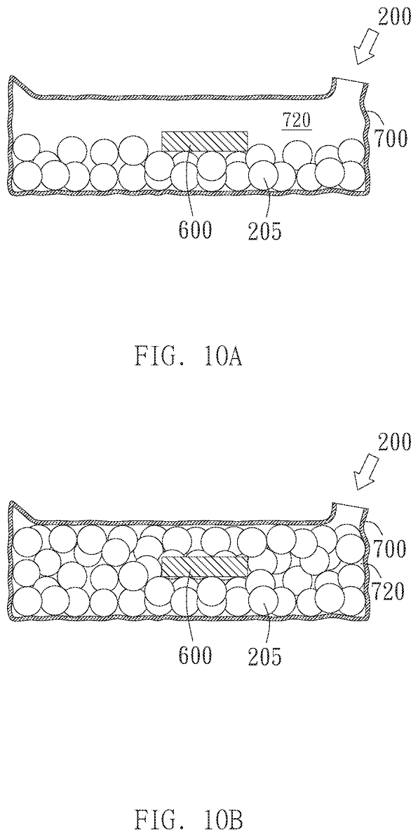

As described above, referring to FIG. 9, after the foaming step S200, the film-like component 700 itself may be welded to the surfaces of the half-foamed granules 205 to form an integrally-formed foam molded body 400, and the pattern 710 originally on the film-like component 700 may correspondingly adhere to the foam molded body 400 (it appears as though the pattern 710 is “printed” on the foam molded body 400). That is, the foam molded body 400 formed by foaming has an indication pattern 710′ corresponding to the pattern 710. For example, the indication pattern 710′ can indicate or describe the type of interior embedded component 600, or can be any decorative pattern. Specifically, according to an embodiment, the film-like component 700 can be a non-foamed material, or it can be a material having the same or similar properties as thermoplastic polyurethane (TPU). Therefore, the surface of the film-like component 700 will only slightly melt when heated by microwaves, and further form an adhesion with the half-foamed material (for example, the half-foamed granules 205) which is foamed and squeezed by microwaves. In this case, since the film-like component 700 is not foamed, it will not be deformed, hence the original position of the pattern 710 will not be changed or affected. Thereby, the indication pattern 710′ corresponding to the pattern 710 can be formed after the foaming step S200. Further, according to another embodiment, the film-like component 700 may be a non-foamed material and may not be a material with the same or similar properties as the thermoplastic polyurethane (TPU). Therefore, when heated by microwaves, the surface of the film-like component 700 will not melt (e.g. like plastic wrap). In this case, the film-like component 700 and the half-foamed material (for example, the half-foamed granules 205) can be coated and positioned by half-foamed material even though it is not easy to achieve stable attachment when they are squeezed by the foaming caused by microwaving, and the original position of the pattern 710 will not change or be affected. Thereby, the indication pattern 710′ corresponding to the pattern 710 can be formed after the foaming step S200. However, the above are merely examples, and the present invention is not limited thereto.

In accordance with yet another embodiment of the present invention, at least one of the film-like component 700 is a waterproof and moisture permeable film (not shown in the drawings). Specifically, the waterproof and moisture permeable film can assist in discharging the sweat of human body in the form of water vapor, and can assist in isolating the infiltration of external water liquid. For example, the waterproof and moisture permeable film may have a waterproofing capacity for more than 1000-2000 mm, and have a moisture permeability of more than 2000-3000 g/m 2/24 hr. However, the above are merely examples, and the waterproof and moisture permeable film can be designed according to the requirements and expectations to have varying degrees of waterproof capability and moisture permeability.

As mentioned above, according to an embodiment of the present invention, the waterproof moisture permeable film may include or may be made of materials that can be heated by microwaves, and may include, for example, a material with properties similar to the half-foamed granules 205. For example, waterproof moisture permeable film may include materials such as polyurethane (PU), thermoplastic polyurethane (TPU) or thermoplastic elastomer (TPE), which do not foam or have negligible foaming capability. As described above, at least part of the foam matrix material 200 may be further coated with a waterproof moisture permeable film before the foaming step S200. Therefore, since the waterproof moisture permeable film has properties in common with the half-foamed granules 205, after the foaming step S200, the waterproof moisture permeable film can have at least part of its surface welded to or coating the foam molded body 400 formed. That is, at least part of the foam molded body 400 may be isolated or coated by a waterproof moisture permeable film which maintains its original properties or structure, thus improving the waterproof capability and moisture permeability of at least part of the foam molded body 400.

Further, according to another embodiment of the present invention, at least one of the film-like components 700 may include foamable materials that can be foamed by microwave heating. Thereby, it can be used to form various detailed structures or shapes of the foam molded body 400 in accordance with the expected design.

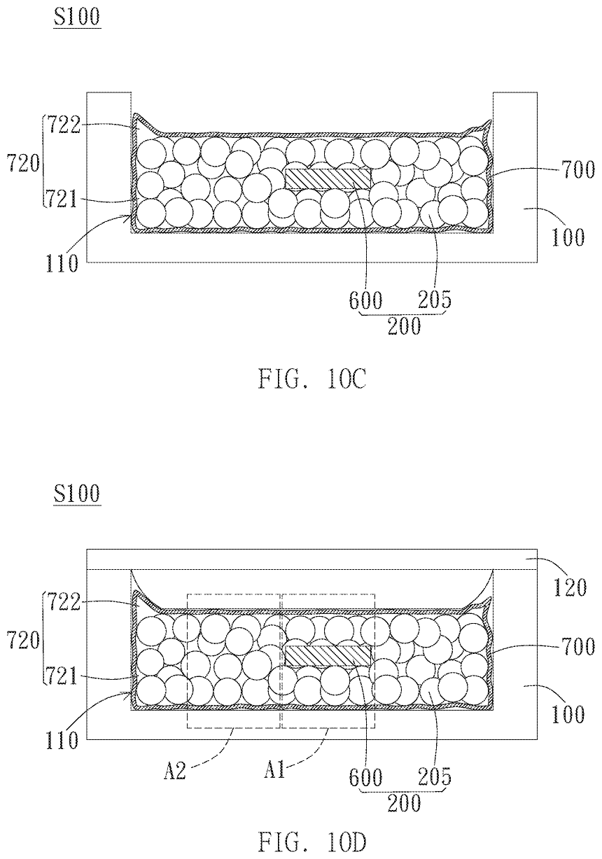

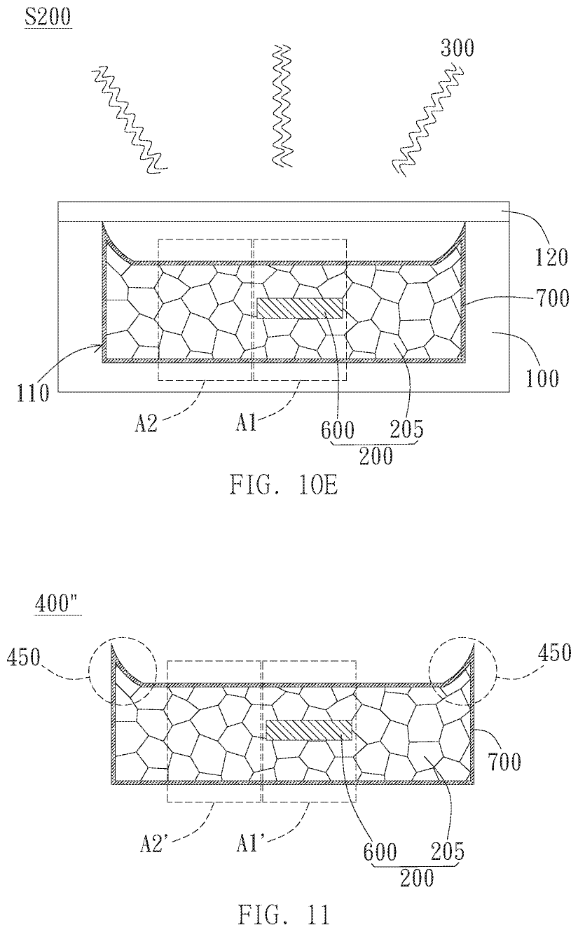

Specifically, with reference to FIG. 10A to FIG.10E, at least one of the film-like components 700 may include a foamable material, or a material that can be partially melted by microwave heating to be welded to other materials, and may envelop an envelopment space 720. Wherein, as shown in FIG. 10A to FIG. 10B in sequence, the foam matrix material 200 which is comprised of the embedded component 600 and the half-foamed granules 205 can be set in the envelopment space 720 enveloped and delimited by the film-like component 700. Next, as shown in FIG. 10C and FIG. 10D sequentially, the film-like component 700 can be closed and the closed film-like component 700 with foam matrix material 200 inside can be set in the mold 100, and the mold 100 can be covered with the top cover 120 to be prepared for foaming. As mentioned above, upon completion of the setting step S200, the envelopment space 720 may include the main space 721 set with half-foamed granules 205 and an extension space 722 without the half-foamed granules 205.

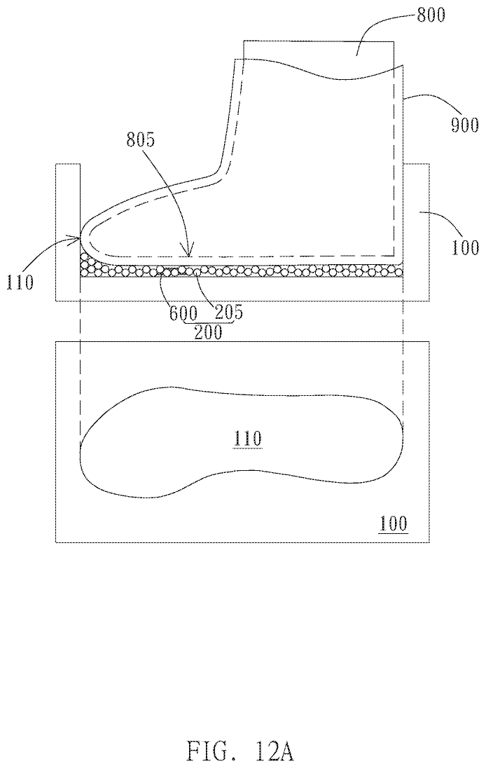

Next, referring to FIG. 10E together with FIG. 10A to FIG. 10D, when the foaming step S200 is performed using the above-described configurations, the half-foamed granules 205 are foamed and expanded along the border of the envelopment space 720 delimited by the film-like component 700, and thus a part of the half-foamed granules 205 that is foaming will expand to fill the extension space 722. Therefore, referring to FIG. 11, the film-like component 700 can be used to reduce the unevenness of the appearance of the foam molded body 400″ caused by the insertion of the embedded component 600 and improve the fineness of the foam molded body 400″.

In detail, as shown in FIG. 10A to FIG. 11, when the embedded component 600 is inserted directly or by other auxiliary positioning elements, the vertical section Al (marked by a dotted line) embedded with embedded component 600 may have a different number of half-foamed granules 205 compared with the adjacent vertical section A2 (marked by a dotted line), and may cause non-uniformity in the appearance of the foamed structure. According to the present embodiment, the possibility of the unevenness can be reduced by defining the desired shape of the film-like component 700 in order to complete the desired appearance of the molded foam body 400″. For example, as shown in FIG. 11, the sections A1′ and A2′ (marked by dotted lines) of the foam molded body 400″ may have substantially equal heights.

Further, as shown in FIG. 11, the completed foam molded body 400″ may have an extended part 450 formed by foaming the half-foamed particles 205 to fill the extended space 722. That is, the desired detail structure or shape can be created by configuring the film-like component 700. For example, a slightly convex flange (extended part 450) can be formed on both sides of the foam molded body 400″. The flanges described above can be used as flanges on both sides of the shoe component, thereby enhancing the strength of the attachment of the shoe component to other portions of the shoe such as the upper, or enhancing the protective strength of the shoe body on both sides of the foot. However, the above is merely an example, and the present invention is not limited to the shape of the envelopment space 720 shown here and the shape of the foam molded body 400″ formed.

As described above, since the method for producing a foam molded body and the so prepared foam molded body according to the present invention can be used for the manufacture of a shoe component, according to other embodiments of the present invention, the foam molded body can be further attached to other parts of the shoe body or made into other parts of the shoe body at the same time that the foam molded body (i.e. the shoe component) is completed. Therefore, the preparation process can be further simplified and the preparation time or cost can be reduced.

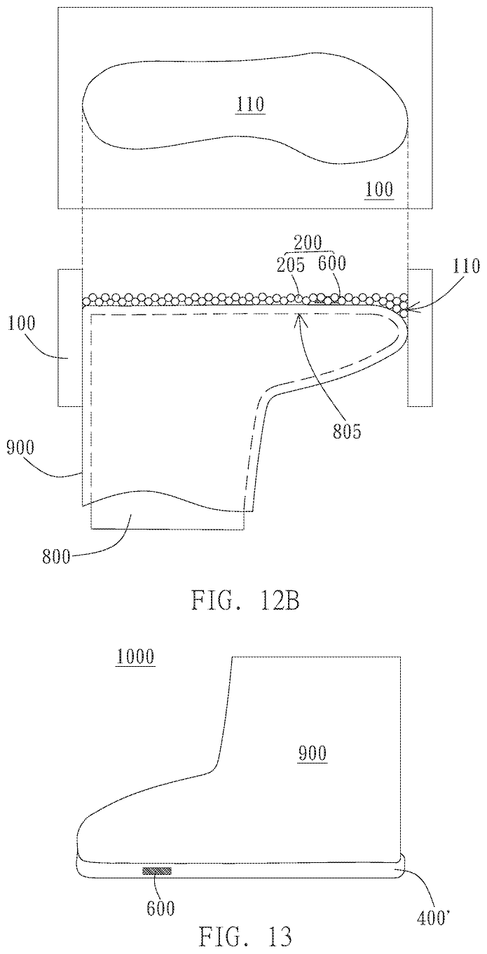

Specifically, referring to FIG. 12A and FIG. 12B, similar to FIG. 2F, the cavity 110 of the mold 100 can have the shape of a shoe component. It is noted that, before the foaming step S200, the shoe last 800 covered with the upper 900 may be further disposed on the mold 100. Here, setting the shoe last 800 on the mold 100 is a relative concept, and is not limited to disposing the shoe last 800 on top of the mold 100 in the direction of gravity. For example, according to the embodiment shown in FIG. 12A, it can occur in the sequence that after the foam matrix material 200, which includes the half-foamed granules 205 and the embedded component 600, is set in the mold 100 in the setting step S100, and then a shoe last 800 covered with an upper 900 is placed above the mold 100 (i.e., in the direction of gravity). Alternatively, according to the embodiment illustrated in FIG. 12B, a shoe last 800 covered with an upper 900 is first placed in the mold 100 (i.e., in the direction opposite to the direction of gravity), and the cavity 110 with the foam matrix material 200 is delimited by the mold 100 and the bottom 805 of the shoe last 800 covered with upper 900. Next, the foam matrix material 200 comprising the half-foamed granules 205 and the embedded component 600 is placed in the mold 100 and carried by the bottom 805 of the shoe last 800 covered with the upper 900.

As shown in FIG. 12A and FIG. 12B, before the foaming step S200, the shoe last 800 covered with the upper 900 may be further disposed on the mold 100 such that at least part of the upper 900 is in contact with the half-foamed granules 205, and the half-molded granules 205 disposed in the mold 100 are distributed along the bottom 805 of the shoe last 800. Therefore, when the half-molded granules 205 are foamed by microwave heating in a fixed space in the foaming step S200, the surfaces of half-molded granules 205 can be welded to each other via foaming, and the bottom 805 along the shoe last 800 can be bonded to the upper 900 at the same time. That is, the half-molded granules 205 may form an integrally-formed shoe component (i.e., the foam molded body 400′) which is bonded to the upper 900 at the point corresponding to the bottom 805 of the shoe last 800. Therefore, after the foaming step S200, the shoe last 800 can be removed to form the shoe 1000 which combines the shoe upper 900 and the shoe component with the embedded component 600 as shown in FIG. 13, and the extra process of bonding the shoe component with the upper 900 is not necessary after forming the shoe component.

According to some embodiments of the present invention, in order to make the shoe component more smoothly bonded to the upper 900 while being formed, the upper 900 may contain a material such as PU, TPU or TPE which does not foam or has a negligible foaming capability. For example, the upper 900 may be woven from PU, TPU or TPE yarns. However, the invention is not limited thereto insofar as it can be bonded to the shoe component (i.e., the foam molded body 400′).

Further, although not shown in the drawings, according to other embodiments of the present invention, the outsole material or the outsole can be laid on the half-famed granules 205 before the foaming step S200. For example, without the shoe last 800 and upper 900 set, the outsole material or the outsole can be simply laid on the half-famed granules 205; or with the shoe last 800 and the upper 900 set, the outsole material or the outsole can be laid on the side of the half-foamed granules 205 opposite to the shoe last 800 and the upper 900. In addition, when the outsole material or the outsole is scattered and not completely laid on the surface of the foam matrix materials 200, the outsole material or the outsole can be laid on the surface of the foam matrix materials 200 according to the pattern expected of the outsole of the shoe. Thereby, one can optionally form the sole, the foam molded body 400′ (for example, the foam molded body 400′ as the midsole) and the upper 900 at the same time by welding their surfaces to each other in the foaming step S200.

According to some embodiments of the present invention, in order to make the shoe component (i.e., the foam molded body 400′) more smoothly bonded to the sole or the sole material while forming, the sole or the sole material may include materials such as PU, TPU or TPE that do not foam or have a negligible foaming capability. However, the present invention is not limited to this when it can be bonded with the shoe component (i.e., foam molded body 400′).

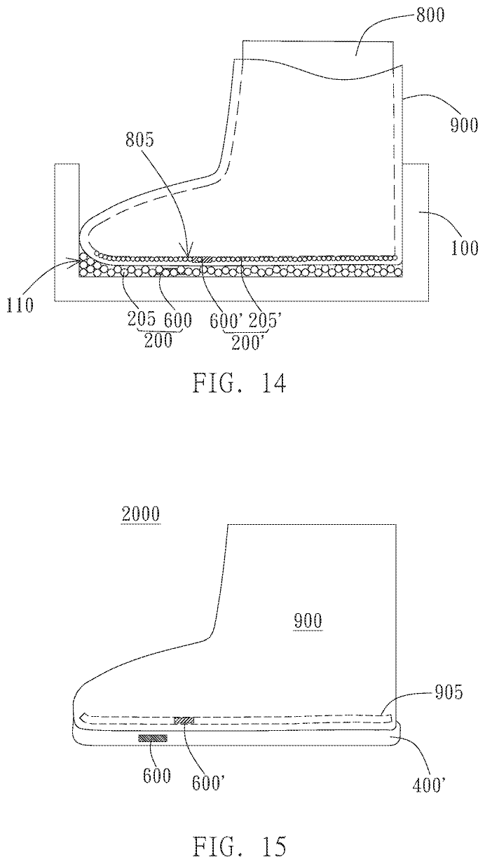

Next, referring now to FIG.14 and FIG. 15, we will continue to describe a first variation embodiment of the above embodiment in which the shoe last 800 is set. Specifically, referring to FIG. 14, when the shoe last 800 covered with the upper 900 is provided, before the foaming step S200, half-foamed granules 205′, which may be of the same or different material from the half-foamed granules 205 in the molded 100 can be additionally distributed and laid along the bottom 805 of the shoe last 800 between the upper 900 and the shoe last 800. That is, the foam matrix material 200′, which includes half-foamed granules 205′, are additionally distributed and laid along the bottom 805 of the shoe last 800 between the upper 900 and the shoe last 800. Therefore, the half-foamed granules 205′ are also foamed by microwave heating in the foaming step S200 (for example, foaming due to temperature rise of itself caused by microwaves or due to temperature rise caused by surrounding materials such as additives). As shown in FIG. 15, the above-mentioned foamed half-foamed granules 205′ can be separately formed into another integrally-formed foam molded body 905 independent of the foam molded body 400′.

As shown in FIG. 14, according to some embodiments, the foam matrix material 200′ may also include an embedded component 600′ in a manner similar to the above principles and methods. The foam molded body 905 formed under this condition may also be embedded with the embedded component 600′.

According to an embodiment, the foam forming body 905 can be a shoe insole of shoe 2000 formed after performing the foaming step S200 under the configuration of FIG. 14. That is, by means of a single foaming step S200, a shoe component (i.e., foam molded body 400′) embedded with embedded component 600 and a shoe insole optionally embedded with embedded component 600′(i.e., foam molded body 905) can be simultaneously formed, and the shoe component (i.e., foam molded body 400′) and the shoe upper 900 can also be bonded.

According to some embodiments of the present invention, the embedded component 600′ can be an object that is the same or different from the embedded component 600, and it is not affected by the microwaves. For example, in the case of an insole, the embedded component 600′ can be an object used for measuring blood pressure, body fat, or a chip for step counting. However, the above is merely an example, and the present invention is not limited thereto.

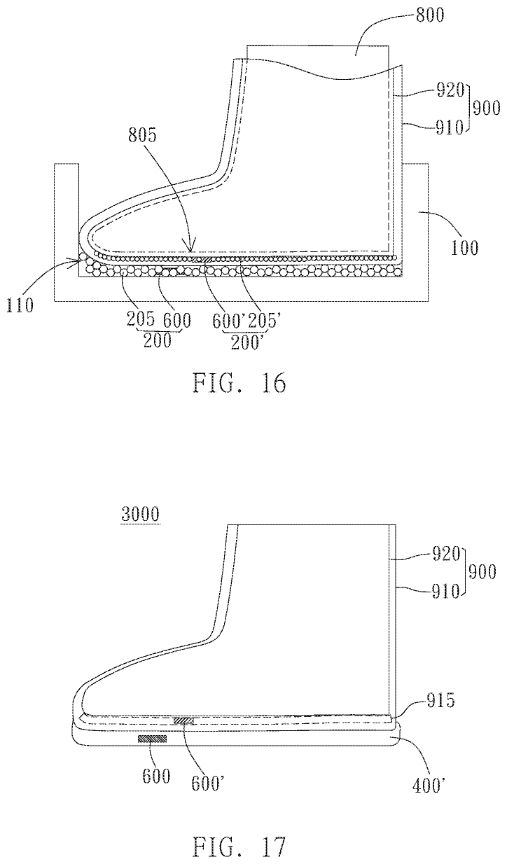

In addition, a second variation embodiment of the above embodiment in which the shoe last 800 is set will be described below with reference to FIG. 16 and FIG. 17. Wherein, according to the second variation embodiment, the shoe last 800 may be covered with a double-layer upper 900, and the structure of the above-mentioned foam molded body can be further formed between the double-layer uppers 900. Specifically, referring to FIG. 16, the upper 900 that covers the shoe last 800 has a double-layer structure including an outer layer 910 and an inner layer 920. Further, similar to the first variation embodiment described above with reference to FIG. 14 and FIG. 15, before the foaming step S200, the half-foamed granules 205′, which is the same or different from the half-foamed granules 205 in the molded 100 are additionally distributed and laid along the bottom 805 of the shoe last 800 between the outer layer 910 and the inner layer 920 of the upper 900. That is, the foamed matrix material 200′ comprising the half-foamed granules 205′ may be additionally disposed and laid along the bottom 805 of the shoe last 800 between the outer layer 910 and the inner layer 920 of the upper 900. Therefore, the half-foamed granules 205′ are also foamed by microwave heating in the foaming step S200 (for example, foaming due to temperature rise of itself caused by microwaves or temperature rise caused by surrounding materials such as additives). As shown in FIG. 17, the above-mentioned foamed half-foamed granules 205′ can be separately formed into another integrally-formed foam molded body 915 independent of the foam molded body 400′.

As shown in FIG. 16, according to some embodiments, the foam matrix material 200′ may also include an embedded component 600′ in a manner similar to the above principles and methods. In this case, the formed foam molded body 915 may also be embedded with the embedded component 600′. The details of the embedded component 600′ are the same as or similar to those described above with reference to FIG. 14 and FIG. 15, and will not be described herein.

According to an embodiment, the foam molded body 915 can be an insole or filler of shoe 3000 formed after performing the foaming step S200 with the configuration of FIG. 16. That is, by means of a single foaming step S200, the shoe component (i.e., foam molded body 400′) embedded with the embedded component 600, the shoe insole or filler (i.e., foam molded body 915) optionally embedded with the embedded component 600 can be simultaneously formed, and the shoe component (i.e., foam molded body 400′) with the upper 900 can also be bonded.

Further, although not shown in the drawings, based on the third variation embodiment of the above-described embodiment where the shoe last 800 is set, the foam molded body 905 or the foam molded body 915 can be directly formed according to the above principle without forming the foam molded body 400′, and an embedded component 600′ can be set inside thereof accordingly. Alternatively, based on the fourth variation embodiment of the above embodiment where the shoe last 800 is set, the foam molded body 905 and the foam molded body 915 can be directly formed simultaneously according to the above principle without forming the foam molded body 400′, and an embedded component 600′ can be set in at least one of the interiors thereof accordingly. Alternatively, based on the fifth variation embodiment of the above embodiment where the shoe last 800 is set, the foam molded body 400′, the foam molded body 905, and the foam molded body 915 can also be simultaneously formed, and an embedded component 600 and/or an embedded component 600′ can be embedded in at least one of the interiors thereof accordingly. As a result, it is to be understood that those skilled in the art can make various changes in accordance with the above principles.

Further, although not shown in the drawings, the waterproof moisture permeable film as described above can also be utilized in the embodiment in which the last 800 and the upper 900 are arranged. Specifically, the waterproof moisture permeable film can cover part of the foam matrix material 200 and part of the upper 900 at the same time, and be bonded with the formed shoe component (i.e., foam molded body 400′) and the upper 900 after the foaming step S200, so that the part of the shoe component (i.e., the foam molded body 400′) and the part of the upper 900 can have the functionality of being waterproof and moisture permeable. Similarly, the waterproof moisture permeable film can also be applied to other foam molded bodies formed as described above, and will not be described herein.

In general, according to various embodiments of the present invention, the production of a foam molded body or a shoe component with an embedded component can be completed in an integrated procedure by using a relatively inexpensive and simple microwave heating process. Specifically, the microwave heating process performed in accordance with various embodiments of the present invention can shorten the process time and save energy, and thus greatly reduce the production cost, compared to the conventional method of injection molding where the matrix material is required to be melted at a high temperature. Further, microwave heating causes the object of heating to be heated up from the inside to the whole in a short time, which is faster and more uniform than the known method of heating from the outside to the inside. With microwave heating, the homogeneity of the final product can be improved, and the microstructures are not easily destroyed and can thus retain better microstructures and corresponding functions. Therefore, the properties and yield of the finished product can be improved, and the prepared foam molded body or shoe component can have a desired embedded component, detail structure, shape or property. Thereby, the applicability of foam molded body can be increased.

The foregoing is merely illustrative of some preferred embodiments of the present invention. It should be noted that various changes and modifications can be made in the present invention without departing from the spirit and scope of the invention. It will be apparent to those skilled in the Art that the present invention is defined by the scope of the appended claims, and that in accordance with the intention of this invention, all possible changes, combinations, modifications, referrals etc., shall not exceed the standard defined by the scope of the apply patent application of the present invention.

What is claimed is:

1. A method of manufacturing a foam molded body comprising:
a setting step, inputting a foaming matrix material into a mold that is not affected by microwaves, wherein the foaming matrix material includes a plurality of half-foamed granules of thermoplastic polyurethane (TPU) and at least an embedded component, and the embedded component is a material that is not affected by microwaves or made of the material; and
a foaming step, heating the mold by microwave, wherein the half-foamed granules in the mold are affected by microwave such that the temperature of the granules are raised to conduct foaming and the granules are squeezed with each other, and the embedded component is therefore squeezed to be fixed, so as to form the foam molded body embedded with the embedded component after cooling and demolding.

2. The method of claim 1, wherein:
in the setting step, inputting one or more positioning components in the mold, and the embedded components are positioned by at least one of the positioning components, and
wherein, the positioning components are made of a half-foamed material, and heated together with half-foamed granules by the method of microwave so that to conduct foaming in the foaming step.

3. The method of claim 2, wherein:
in the setting step, separating the mold into different regions by at least one of the positioning components, and respectively setting the half-foamed granules with a plurality of first granules of a first granule size range and a plurality of second granules of a second granule size range in the different regions,
wherein, the median of the first granule size range is substantially greater than the median of the second granule size range.

4. The method of claim 1, wherein the cavity of the mold is in the shape of a shoe component, and the foam molded body is a shoe component.

5. The method of claim 4, before the foaming step, further comprising setting a shoe last that covered with an upper on the mold so that at least a portion of the upper is contacted to the half-foamed granules and the half-foamed granules arranged on the mold are distributed along the bottom of the shoe last.

6. The method of claim 5, before the foaming step, further comprising distributing half-foamed granules that are the same as or different from the half-foamed granules in between of the upper and the shoe last along the bottom of the shoe last.

7. The method of claim 5, wherein the upper covering the shoe last has a two-layer structure, and before the foaming step, the method of manufacturing the foam molded body further comprises distributing half-foamed granules that are the same as or different from the half-foamed granules of additional distribution in between of an inner layer and an outer layer of the upper along the bottom of the shoe last.

8. According to the method of claim 1, wherein: in the setting step, partially disposing one or more film-like components in the mold to be in contact with the half-foamed granules,
wherein, the film-like components include a material that can be heated by microwaves.

9. The method of claim 8, wherein at least one of the film-like components is a waterproof moisture-permeable film, and before the foaming step, the method of fabricating the foam molded body further comprises covering at least a portion of the foamed matrix material with the waterproof moisture-permeable film.

10. The method of claim 8, wherein at least one of the film-like components has a pattern, and the foam molded body formed by foaming has an indication pattern corresponding to the pattern.

11. The method of claim 8, wherein at least one of the film-like components includes a foamable material or a material that can be heated in a microwave manner to partially melt and connect to other materials, the film-like components also define a cladding space, at least a portion of the foaming matrix materials which disposed in the mold is disposed in the cladding space,
wherein, the cladding space includes an extension space without having the half-foamed granules; and
wherein, the foam molded body has an extended section that is formed by foaming the half-foamed granules to fill the extension space.

12. A foam molded body made by the method of claims 1, wherein:
the embedded component is squeezed and fixedly embedded in a foamed structure in which the surface of the half-foamed granules is squeeze-welded to each other by foaming.

13. A shoe component made by the method of claims 1, wherein:
the shoe component is the foam molded body with the shape of the shoe component, and the embedded component is squeezed and fixedly embedded in a foamed structure in which the surface of the half-foamed granules is squeeze-welded to each other by foaming.

14. A foam molded body comprising:
a foamed structure formed by foaming a plurality of half-foamed granules of thermoplastic polyurethane (TPU); and
at least one embedded component is a material that is not affected by microwaves or made of the material, and the embedded component is extruded and fixedly embedded in the foamed structure in which the surface of the half-foamed granules is squeeze-welded to each other by foaming.

15. The foam molded body of claim 14, wherein the half-foamed granules with a plurality of first granules of a first granule size range and a plurality of second granules of a second granule size range, wherein,
the median of the first granule size range is substantially greater than the median of the second granule size range, and
the portion hardness formed by the first granules foamed is less than the portion hardness formed by the second granules foamed.

16. The foam molded body of claim 14, further comprising one or more film-like components mutually welded or bonded to the half-foamed granules surfaces.

17. The foam molded body of claim 16, wherein the at least one of the patterns of the film-like components corresponding attached to the foam molded body.

18. The foam molded body of claim 16, wherein at least one of the film-like components is a waterproof moisture permeable film.

19. The foam molded body of claim 16, wherein at least one of the film-like components covers the foamed structure.

20. The foam molded body of claim 14, wherein the foam molded body is a shoe component with a shape of a shoe component, wherein the shoe component is bonded to at least a portion of an upper in a welded form.
